(19) United States
(12) Patent Application Publication
(10) Pub. No.: US 2018/0280804 A1
(43) Pub. Date: Oct. 4, 2018

(54) PROGRAM AND SYSTEM

(71) Applicant: KABUSHIKI KAISHA SQUARE ENIX (also trading as SQUARE ENIX CO., LTD.), Tokyo (JP)

(72) Inventors: Hiroshi MINAGAWA, Tokyo (JP); Kei MUTA, Tokyo (JP); Kei ODAGIRI, Tokyo (JP)

(73) Assignee: KABUSHIKI KAISHA SQUARE ENIX (also trading as SQUARE ENIX CO., LTD.), Tokyo (JP)

(21) Appl. No.: 15/940,090

(22) Filed: Mar. 29, 2018

(30) Foreign Application Priority Data
Mar. 31, 2017 (JP) 2017-070367

(51) Int. Cl. A63F 13/69; A63F 13/52; A63F 13/55; A63F 13/352

(52) U.S. Cl. CPC A63F 13/69; A63F 13/352; A63F 13/55; A63F 13/52

(57) ABSTRACT

A non-transitory computer-readable medium including a program for causing a server to realize functions to control progress of a video game including a three-dimensional virtual space, the three-dimensional virtual space having a boundary through which a player character is allowed to move to another three-dimensional virtual space is provided. The functions include: a specifying function configured to specify a position of the player character in the three-dimensional virtual space; and a displaying function configured to change a scare of a boundary object on the basis of the position of the player character to display the boundary object, the boundary object being an object that is provided on or near the boundary. further, the displaying function includes a function configured to change a positron of the boundary object on the basis of a change in the position of the player character to display the boundary object.

### CROSS-REFERENCE TO RELATED APPLICATION

The present application relates to subject matter contained in Japanese Patent Application No. 2017-70367 filed on Mar. 31, 2017, the disclosure of which is expressly incorporated herein by reference in its entirety.

### BACKGROUND OF THE INVENTION

### 1. Field of the Invention

At least one of embodiments according to the present invention relates to a non-transitory computer-readable medium including a program for causing a server to realize functions to control progress of a video game including a three-dimensional virtual space that has a boundary through which a player character is allowed to move to another three-dimensional virtual space. Further, at least one of the embodiments according to the present invention relates to a system configured to control progress of a video game including a three-dimensional virtual space that has a boundary through which a player character is allowed to move to another three-dimensional virtual space, the system comprising a communication network, a server, and a user terminal, the three-dimensional virtual space. Moreover, at least one of the embodiments according to the present invention relates to a non-transitory computer-readable medium including a program for causing a user terminal to realize functions to control progress of a video game including a three-dimensional virtual space that has a boundary through which a player character is allowed to move to another three-dimensional virtual space.

### 2. Description of the Related Art

Heretofore, there is a video game in which when a character in the video game arrives at an entrance and exit port to another stage provided in a field, the character is caused to move to a field corresponding to a new stage (that is, another stage).

In such a video game system, there is one in which in order to show a user that there is an entrance and exit port of a stage in the neighborhood, in a case where a character arrives at a notice region that exists within a predetermined distance from the entrance and exit port, a screen in which a non-display region is partially generated is generated (see Japanese Patent Application Publication No. 2005-319018).

However, in such a video game system, it is difficult to cause the user to intuitively recognize where a boundary such as an entrance and exit port of a stage. Further ingenuity regarding an interface, which is used to cause the user to intuitively recognize the boundary, has been required.

### SUMMARY OF THE INVENTION

It is an object of at least one of embodiments according to the present invention to cause a user to recognize a boundary more intuitively, whereby it is possible to improve usability in a video game, in which a player character or the like may be controlled to move toward the boundary compared with the conventional ones.

According to one non-limiting aspect of the present invention, there is provided a non-transitory computer-readable medium including a program, for causing a server to realize functions to control progress of a video game including a three-dimensional virtual space, the three-dimensional virtual space having a boundary through which a player character is allowed to move to another three-dimensional virtual space.

The functions include a specifying function configured to specify a position of the player character in the three-dimensional virtual space.

The functions also include a displaying function configured to change a state of a boundary object on the basis of the position of the player character to display the boundary object, the boundary object being an object that is provided on or near the boundary.

According to another non-limiting aspect of the present invention, there is provided a system configured to control progress of a video game including a three-dimensional virtual space, the system comprising a communication network, a server, and a user terminal, the three-dimensional virtual space having a boundary through, which a player character is allowed to move to another three-dimensional virtual space.

The system includes a specifying section configured to specify a positron of the player character in the three-dimensional virtual space.

The system also includes a displaying section configured to change a stats of a boundary object on the basis of the position of the player character to display the boundary object, the boundary object being an object that is provided on or near the boundary.

According to still another non-limiting aspect of the present invention, there is provided a non-transitory computer-readable medium including a program product for causing a user terminal to realize functions to control progress of a video game including a three-dimensional virtual space, the three-dimensional virtual space having a boundary through which a player character is allowed to move to another three-dimensional virtual space.

The functions include a specifying function configured to specify a position of the player character in the three-dimensional virtual space.

The functions also include a displaying function configured to change a state of a boundary object on the basis of the position of the player character to display the boundary object, the boundary object being an object that is provided on or near the boundary.

According to each of the embodiments of the present application, one or two or more shortages are solved.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings:

FIG. 1 is a block diagram showing an example of a configuration of a system corresponding to at least one of embodiments according to the present invention.

FIG. 2 is a block diagram showing a configuration of a server corresponding to at least one of the embodiments according to the present invention.

FIG. 3 is a flowchart showing an example of display processing corresponding to at least one of the embodiments according to the present invention.

FIG. 4 is a flowchart showing an example of an operation of a server side in the display processing corresponding to at least one of the embodiments according to the present invention.

FIG. 5 is a flowchart showing an example of an operation of a terminal side in the display processing corresponding to at least one of the embodiments according to the present invention.

FIG. 6 is a block diagram showing a configuration of a server corresponding to at least one of the embodiments according to the present invention.

FIG. 7 is a flowchart showing an example of the display processing corresponding to at least one of the embodiments according to the present invention.

FIG. 8 is a block diagram showing a configuration of a server corresponding to at least one of the embodiments according to the present invention.

FIG. 9 is a flowchart showing an example of the display processing corresponding to at least one of the embodiments according to the present invention.

FIG. 10 is a block diagram showing a configuration of a server corresponding to at least one of the embodiments according to the present invention.

FIG. 11 is a flowchart showing an example of the display processing corresponding to at least one of the embodiments according to the present invention.

FIG. 12 is an explanatory drawing for explaining an example of a display screen corresponding to at least one of the embodiments according to the present invention.

FIG. 13 is a block diagram showing a configuration of a server corresponding to at least one of the embodiments according to the present invention.

FIG. 14 is a flowchart showing an example of the display processing corresponding to at least one of the embodiments according to the present invention.

FIGS. 15(A)-15(C) are explanatory drawings for explaining an example of the display screen corresponding to at least one of the embodiments according to the present invention.

### DETAILED DESCRIPTION OF THE INVENTION

Hereinafter, examples of embodiments according to the present invention will be described with reference to the drawings. In this regard, various kinds of elements in an example of each embodiment, which will be described below, can appropriately be combined with each other in a range where contradiction or the like did not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like did not occur in the content of the processing.

### First Embodiment

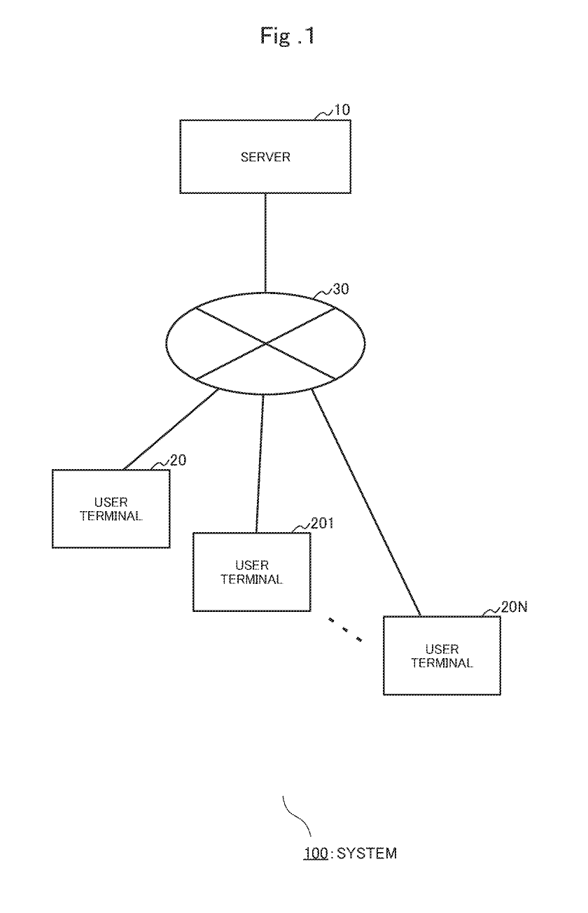

FIG. 1 is a block diagram showing an example of a configuration of a system 100 according to one embodiment of the present invention. As shown in FIG. 1, the system 100 includes a server 10 and a plurality of user terminals 20 and 201 to 20N (“N” is an arbitrary integer), each of which is used by a user of the system 100. In this regard, a configuration of the system 100 is not limited to this configuration. The system 100 may be configured so that a plurality of users uses a single user terminal, or may be configured so as to include a plurality of servers.

Each of the server 10A and the plurality of user terminals 20 and 201 to 20N is connected to a communication network 30 such as the Internet. In this regard, although it is not shown in the drawings, the plurality of user terminals 20 and 201 to 20N is connected to the communication network 30 by carrying out data communication with base stations managed by a telecommunication carrier by means of a radio communication line.

The server 10 is managed by an administrator of the system 100. The server 10 has various kinds of functions to control progress of a video game that includes a three-dimensional virtual space having a boundary through which a player character is caused to move from one three-dimensional virtual space to another three-dimensional virtual space, and has various kinds of functions to provide information regarding the various kinds of processes to the plurality of user terminals 20, 201 to 20N. In the present embodiment, the server 10 is constructed by an information processing apparatus, such as a WWW server, and includes a storage medium for storing various kinds of information. In this regard, the server 10 is provided with a general configuration for carrying out the various kinds of processes, such as a control section and a communicating section, as a computer. However, its explanation herein is omitted. Further, in the system 100, it is preferable that the system is configured so that the server 10 manages various kinds of information from a point of view to reduce a processing load on each of the plurality of user terminals 20, 201 to 20N. However, a storage region may be provided in a state that the server 10 can access the storage region. For example, the system 100 may be configured so that a dedicated storage region is provided outside the server 10.

Here, the player character means a character that becomes an operation target of the user (or a player). The character is not limited particularly so long as the character is an object that appears in the video game. As examples of the character, there are a humanoid object, an object of an automobile, an object of a robot on which a person gets, and the like.

Further, the boundary means a region that is a trigger to move to another three-dimensional virtual space. The boundary according to the present embodiment is set in advance so as to have a fixed region at a part of the three-dimensional virtual space. A position at which the boundary is set is determined in advance for each three-dimensional virtual space. In this regard, a method of setting the position is not limited particularly. The method may be a fixed method, or a dynamic method. As an example of dynamically setting, there is a configuration in which a boundary moves in accordance with a predetermined rule, for example, elapse of time. Information on destination corresponding to the boundary is set in advance to each boundary. The player character is allowed to move, as a condition that the player character reaches a boundary, to another three-dimensional virtual space corresponding to the reached boundary. For that reason, in the video game according to the present system, the user may carry out an operation to cause the player character to move toward a boundary.

Further, the phrase “progress of the video game” means occurrence of various kinds of progress or changes and the like that can be generated in the video game. As one example of the phrase “occurrence of various kinds of progress or changes and the like that can be generated in the video game”, there are progress of time, a change in a parameter of a game element, update of a specific status or a flag, or an operational input by the user, and the like.

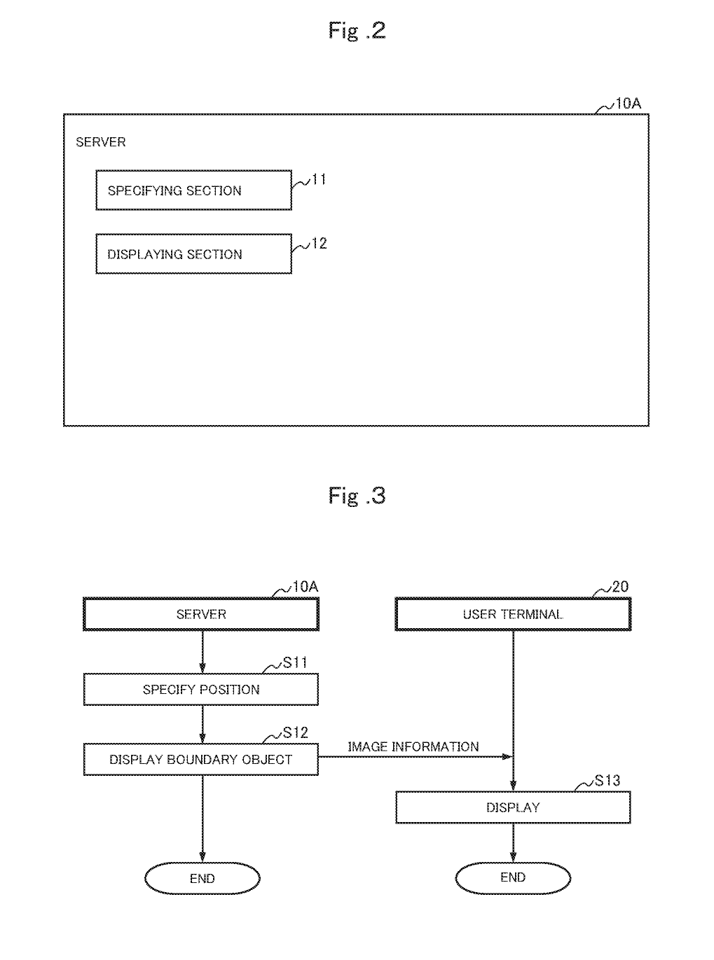

FIG. 2 is a block diagram showing a configuration of a server 10A, which is an example of the configuration of the server 10. As shown in FIG. 2, the server 10A at least includes a specifying section 11 (which corresponds to one example of a specifying function) and a displaying section 12 (which corresponds to one example of a displaying function).

The specifying section 11 has a function to carry out a process to specify a position of the player character in the three-dimensional virtual space. The configuration to carry out a process of specifying the position is not limited particularly. As an example of the configuration to specify the position of the player character, there is a configuration in which the server 10A specifies positional information regarding the position of the player character, which is processed and determined on the basis of an operational input of the user who operates the player character. Here, the positional information regarding the position of the player character is managed by the server 10A as information that is appropriately updated in response to an operational input by the user who operates the player character.

The displaying section 12 has a function to carry out a process to change a state of a boundary object, which is an object that is provided on or near the boundary, on the basis of the position of the player character to display the boundary object. Namely, the displaying section 12 controls the boundary object so that the state of the boundary object is changed on the basis of the position of the player character, and displays a control result thereof.

Here, the object that is provided on or near the boundary means an object that is displayed on or near the boundary when a predetermined condition is satisfied. Further, as examples of the object displayed at the boundary mentioned herein, there are an object that is displayed on a boundary surface by providing the object on a surface constituting the boundary, an object that is displayed integrally with the boundary by providing the object integrally with the boundary, an object that is displayed in a form to cause the user to recognize that the boundary exists in the vicinity of the object by providing the object in the vicinity of the boundary and along the boundary, and the like. Namely, the boundary object is displayed at least in the vicinity of the boundary. Therefore, the user can recognize that the boundary exists at least in the vicinity of the boundary object. In this regard, the system 100 may be configured so as not to display the boundary object in a case where the predetermined condition is satisfied.

Further, the state of the boundary object means a state, condition or status of the boundary object that can be changed on the basis of a certain condition. Examples of the state of the boundary object are not limited particularly. However, it is preferable that the state of the boundary object is a state regarding display of the boundary object (that is, a display state thereof). As examples of the state of the boundary object, there are a form, a position, a size, and permeability of the boundary object itself. As one example of the configuration to change the state of the boundary object on the basis of the position of the player character, there is a configuration in which permeability of the boundary object itself becomes higher as the player character goes away from the boundary.

Further, the phrase “display a boundary object” means that a display device included in the user terminal is caused to display a game screen, by which the boundary object can be recognized, on a display screen. Further, the phrase “the display device is caused to display the game screen on the display screen” means that the game screen is outputted to the display device included in each of the user terminals 20, 201 to 20N via communication using the communication network 30. As an example of the configuration to cause the display device to display the game screen, there is a configuration in which information generated at the server 10 side (for example, screen information) is transmitted to the user terminals 20, 201 to 20N side. In this regard, the example of the screen information is not limited particularly. For example, the screen information may be information obtained by compressing data on the game screen, or information for causing each of the user terminals 20, 201 to 20N to generate the game screen. As an example of the information obtained by compressing data on the game screen, there is one used in Cloud gaming (for example, MPEG). Further, as an example of the information for causing each of the user terminals 20, 201 to 20N to generate the game screen, there is one used in an online game.

Each of the plurality of user terminals 20, 201 to 20N is managed by a user (or a player) who plays the video game, and is configured by a communication terminal, such as a cellular phone terminal, a PDA (Personal Digital Assistants), a mobile game device, and a so-called wearable divide, by which the user can play a network delivery type game, for example. In this regard, the configuration of the user terminal that the system 100 can include is not limited to the examples described above. It may be a configuration in which the user can recognize the video game. As other examples of the user terminal, there is a combination of a so-called wearable device, such as a smart watch, and a communication terminal or the like configured to communicate with the wearable device.

Further, each of the plurality of user terminals 20, 201 to 20N is connected to the communication network 30, and includes hardware (for example, a display device for displaying a game screen, an audio output device arid the like) and software for carrying out the video game by communicating with the server 10. In this regard, each of the plurality of user terminals 20, 201 to 20N may be configured so as to be capable of directly communicating with each other without the server 10. Further, each of the plurality of user terminals 20, 201 to 20N outputs an image of the video game to the display device included therein on the basis of information transmitted from the server 10 (for example, information regarding a game image).

Next, an operation of the system 100 according to the present embodiment will be described.

FIG. 3 is a flowchart showing an example of display processing carried oat by the system 100. Hereinafter, the case where the server 10A and the user terminal 20 (hereinafter, referred to as a “terminal 20”) carry out transmission and reception of data regarding the video game will be described as an example. The display processing according to the present embodiment is carried out at predetermined timing when a boundary object is displayed, for example.

In the display processing, the server 10A first specifies a position of the player character (Step S11). For example, the server 10A specifies positional information regarding the position of the player character from a storage region in which the positional information regarding the position of the player character processed and determined on the basis of an operational input of the user who operates the player character is managed.

When the positional information is specified, the server 10A changes a state of the boundary object on the basis of the position of the player character to display the boundary object (Step S12). For example, the server 10A changes the state of the boundary object on the basis of the position of the player character. The server 10A then generates screen information for causing the display device included in the user terminal 20 to display a game screen, which allows the user to recognize the boundary object whose state is changed, on the display screen, and transmits the generated screen information to the terminal 20.

The terminal 20 receives the screen information from the server 10A; displays the game screen that allows the user to recognize the boundary object whose state is changed on the basis of the screen information (Step S13); and terminates the processing herein.

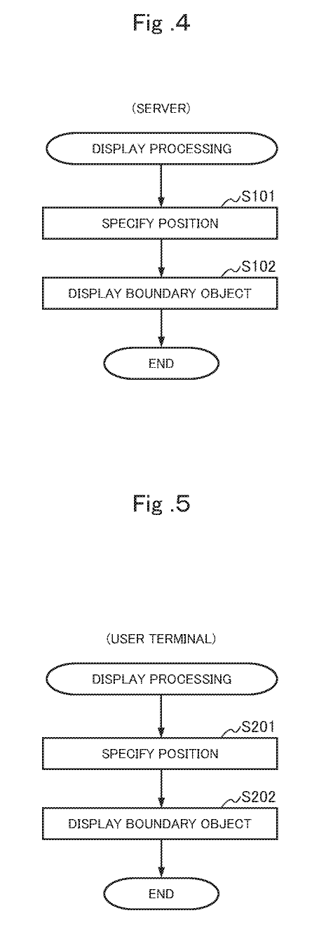

FIG. 4 is a flowchart showing an example of an operation of the server 10A side in the display processing. Here, an operation of the server 10A in the system 100 will be described again. Further, the display processing according to the present embodiment is carried out at predetermined timing when a boundary object is displayed, for example.

In the display processing, the server 10A first specifies a position of the player character (Step S101); changes a state of the boundary object on the basis of the position of the player character to display the boundary object (Step S102); and terminates the processing herein. For example, the server 10A changes the state of the boundary object on the basis of the position of the player character. The server 10A then generates screen information for causing the display device included in the user terminal 20 to display a game screen, which allows the user to recognize the boundary object whose state is changed, on the display screen, and transmits the generated screen information to the terminal 20.

FIG. 5 is a flowchart showing an example of an operation of the terminal 20 side in a case where the terminal 20 carries out the display processing. Hereinafter, the case where the terminal 20 carries out the display processing by a single body will be described as an example. In this regard, the terminal 20 is configured to include the similar functions to those of the server 10. For this reason, its description will be omitted from a point of view to avoid repeated explanation. Further, the display processing according to the present embodiment is carried out at predetermined timing when a boundary object is displayed, for example.

In the display processing, the terminal 20 first specifies a position of a player character (Step S201); changes a state of a boundary object on the basis of the position of the player character to display the boundary object (Step S202); and terminates the processing herein.

As explained above, as one side of the first embodiment, the server 10A configured to control progress of the video game including the three-dimensional virtual space, which has the boundary through which the player character is allowed to move to another three-dimensional virtual space is configured so as to at least include the specifying section 11 and the displaying section 12. Thus, the specifying section 11 specifies the position of the player character in the three-dimensional virtual space; and the displaying section 12 changes the state of the boundary object, which is an object that is provided on or near the boundary, on the basis of the position of the player character to display the boundary object. Therefore, it is possible to cause the user to recognize the boundary more intuitively, and this makes it possible to improve usability in the video game in which the player character or the like may be controlled to move toward the boundary compared with the conventional ones.

Namely, the boundary object is displayed on or near the boundary in the state according to the position of the player character. Therefore, it becomes possible to cause the user to more intuitively recognize how far position from the position of the player character the boundary exists.

In this regard, it has not been mentioned particularly in the first embodiment described above. However, it is preferable that the boundary object is configured so that the user cannot recognize the boundary object like a wall. As an example of such a configuration, there is a configuration in which the boundary object is configured as a plane along a boundary surface and is displayed at a part of the boundary. According to this example, even in a case where three-dimensional movement (that is, for example, in the air or under the water, movement to a Y-Z plane in addition to conventional movement to an X-Y plane) is carried out in the three-dimensional virtual space, it is possible to cause the user to easily grasp on which surface (or where) the boundary exists. For that reason, it is useful to carry out boundary display by which the user is allowed to intuitively recognize the boundary without hindering a landscape or scenery drawn in a world of the video game.

### Second Embodiment

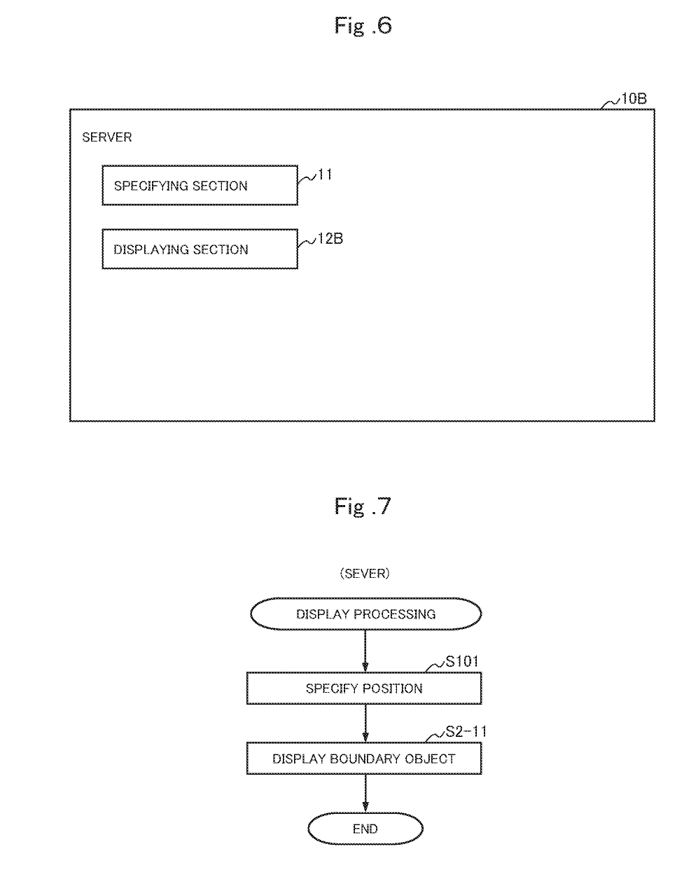

FIG. 6 is a block diagram showing a configuration of a server 10B, which is an example the configuration of the server 10. In the present embodiment, the server 10B at least includes a specifying section 11 and a displaying section 12B.

The displaying section 12B has a function to carry out a process to change a position of a boundary object on the basis of a position of a player character to display the boundary object. Namely, when the player character moves, the boundary object is display so as to move. As one example of a configuration of movement of the boundary object, there is a configuration in which a boundary object displayed on a boundary moves on the boundary (that is, a predetermined display portion of boundary object) so as to follow the movement of the player character. Namely, the position of the boundary object on or near the boundary is changed in accordance with a change in the position of the player character.

FIG. 7 is a flowchart showing an example of the display processing carried out by the system 100. Hereinafter, an operation of the server 10B side will be described as an example. In this regard, description of components or portions that have already been explained will be omitted from a point of view to avoid repeated explanation.

In the display processing, the server 10B first specifies a position of the player character (Step S101); changes a position of the boundary object on the basis of a change in the position of the player character to display the boundary object (Step S2-11); and terminates the processing herein. For example, the displaying section 12B displays the boundary object by using a position of the boundary, which is the closest to the position of the player character, as a reference position of the boundary object, thereby displaying the boundary object so that the position of the boundary object is changed while the position of the player character is changed.

As explained above, as one side of the second embodiment, the server 10B is configured so as to at least include the specifying section 11 and the displaying section 12B. Thus, the displaying section 12B changes the position of the boundary object on the basis of the change in the position of the player character to display the boundary object. Therefore, it is possible to cause the user to recognize the boundary more intuitively, whereby it is possible to improve usability in the video game in which the player character or the like may be controlled to move toward the boundary compared with the conventional ones.

In this regard, it has not been mentioned particularly in the second embodiment described above. However, the server 10B may be configured so that the displaying section 12B displays the boundary object by using a position of the boundary, which is the closest to the position of the player character, as a reference position of the boundary object. In this case, the reference position of the boundary object means a position that is set in advance. As one example of the reference position of the boundary object, there is a position that becomes a center of the boundary object. By configuring the server 10B in this manner, it is possible to further improve usability of the video game compared with the conventional one in view of a situation in which the user can understand where the nearest portion of the boundary is. Further, even in a case where the player character cannot move linearly on the shortest route, it is possible to peculiarly improve the usability compared with the conventional one in view of a situation in which by updating the shortest position in accordance with movement so as to deviate the shortest route, the boundary object indicating the shortest route of the moment is displayed.

Namely, the position of the boundary object on or near the boundary changes in accordance with the change in the position of the player character. For this reason, it becomes possible to cause the user to more intuitively recognize how far position from the position of the player character the boundary exists.

In this regard, it has not been mentioned particularly in the second embodiment described above. However, the server 10B may be configured so that the displaying section 12B changes the position of the boundary object on the basis of movement of the player character in a parallel direction toward a surface on or near which the boundary object is formed.

### Third Embodiment

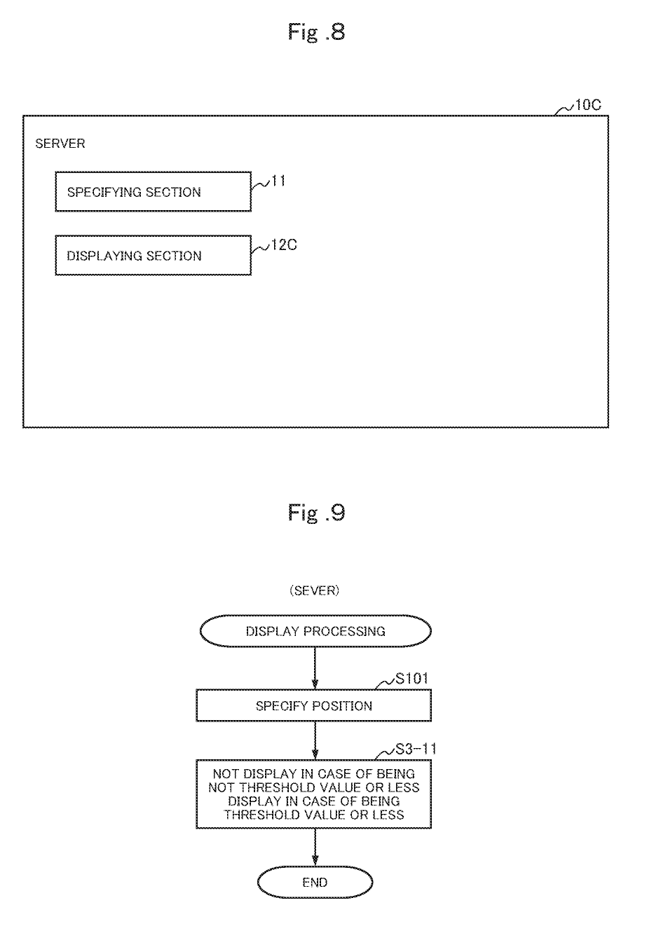

FIG. 8 is a block diagram showing a configuration of a server 10C, which is an example of the configuration of the server 10. In the present embodiment, the server 10C at least includes a specifying section 11 and a displaying section 12C.

The displaying section 12C further has a function to carry out a process to display or not to display a boundary object on the basis of a distance between a player character and a boundary. For example, the displaying section 12C does not display the boundary object in a case where the distance between the player character and the boundary exceeds a predetermined threshold value; and displays the boundary object in a case where the distance between the player character and the boundary becomes the predetermined threshold value or shorter. As an example of the predetermined threshold value, it is preferable that distance settings are carried out so that the boundary object is not displayed when the player character goes away from the boundary object to a certain extent. However, the predetermined threshold value is not limited to such a configuration particularly.

Here, the distance between the player character and the boundary means a length of the shortest line of numerous lines each of which connects a position of the player character to the boundary. In this regard, this distance may be a distance between the player character and a position at which the boundary object is displayed.

FIG. 9 is a flowchart showing an example of display processing carried out by the system 100. Hereinafter, an operation of the server 10C side will be described as an example. In this regard, description of components or portions that have already been explained will be omitted from a point of view to avoid repeated explanation.

In the display processing, the server 10C first specifies a position of the player character (Step S101); does not display a boundary object in a case where a distance exceeds a predetermined threshold value on the basis of the distance between the player character and a boundary, and display the boundary object in a case where the distance becomes the predetermined threshold value or shorter (Step S3-11); and terminates the processing herein. For example, the server 10C determines whether the distance between the player character and the boundary exceeds the predetermined threshold value or not. In a case where it is determined that the distance between the player character and the boundary does not exceed the predetermined threshold value, the server 10C terminates the processing herein. On the other hand, in a case where it is determined that the distance between the player character and the boundary exceeds the predetermined threshold value, the server 10C does not display the boundary object (or terminates display of the boundary object). After the boundary object is not displayed, the server 10C determines whether the distance between the player character and the boundary becomes the predetermined threshold value or shorter or not. In a case where it is determined that the distance between the player character and the boundary does not become the predetermined threshold value or shorter, the server 10C terminates the processing herein. On the other hand, in a case where it is determined that the distance between the player character and the boundary becomes the predetermined threshold value or shorter, the server 10C displays the boundary object, and terminates the processing herein.

As explained above, as one side of the third embodiment, the server 10C is configured so as to at least include the specifying section 11 and the displaying section 12C. Thus, the displaying section 12C does not display the boundary object in a case where the distance between the player character and the boundary exceeds the predetermined threshold value, and the displaying section 12C displays the boundary object in a case where the distance between the player character and the boundary becomes the predetermined threshold value or shorter. Therefore, it is possible to cause the user to recognize the boundary more intuitively, and this makes it possible to improve usability in the video game in which the player character or the like may be controlled to move toward the boundary compared with the conventional ones.

In this regard, it has not been mentioned particularly in the third embodiment described above. However, the displaying section 12C may further be configured so that the boundary object is not displayed even in a case where the distance between the player character and the boundary becomes the predetermined threshold value or shorter. Namely, the user can select the setting that the boundary object is not displayed in any situation.

### Fourth Embodiment

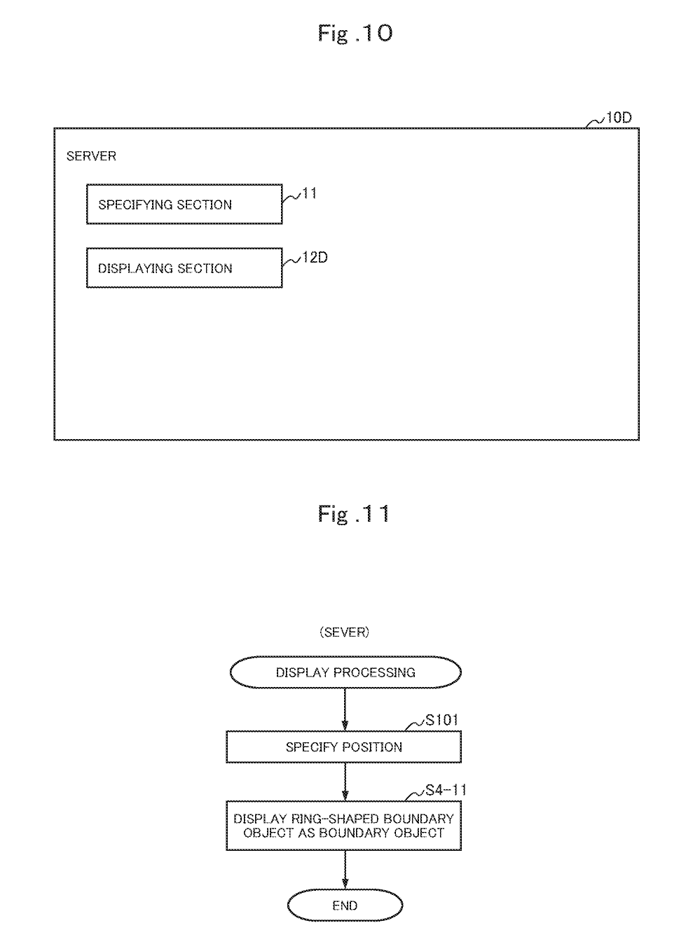

FIG. 10 is a block diagram showing a configuration of a server 10D, which is an example of the configuration of the server 10. In the present embodiment, the server 10D at least includes a specifying section 11 and a displaying section 12D.

The displaying section 12D has a function to carry out a process to display a ring-shaped object as a boundary object.

Here, the ring-shaped object is not limited to an object having a perfect circular shape. Namely, the ring-shaped object may be an object in which an outline thereof is formed in a pleated manner.

Further, the displaying section 12D also has a function to carry out a process to display the boundary object so that a center of the boundary object always corresponds to a position of a player character while the boundary object is being displayed.

Here, a configuration to specify a position of a boundary object is not limited particularly so long as it is a configuration in which the position of the boundary object is specified so as to correspond to the position of the player character. Namely, the configuration may be a configuration in which a state where a center of the boundary object does not correspond to the position of the player character may temporarily occur. As an example of the configuration in which the center of the boundary object, always corresponds to the position of the player character, there is a configuration in which the server 10D specifies the position of the player character, and determines a position of a boundary, which is the closest to the position of the player character, as a center of the ring-shaped object.

Further, the center of the boundary object includes a position corresponding to a substantially central position of the boundary object in a case where the ring-shaped object as the boundary object has a non-perfect circular shape. It is preferable that the center of the boundary object or a position corresponding to the center of the boundary object is a position set in advance for the boundary object.

Further, the displaying section 12D also has a function to carry out a process to change a state of the boundary object so that a diameter of the boundary object becomes narrower as the player character approaches the boundary object to display the boundary object. For example, the displaying section 12D determines the diameter of the ring-shaped object by using a predetermined calculation formula defined so that the diameter of the ring-shaped object narrows as the player character approaches the ring-shaped object. As an example of the predetermined calculation formula, there is a calculation formula “(diameter of ring-shaped object)=(basic diameter)×(distance between player character and ring-shaped object)”. The server 10D may be configured so as to: store the predetermined calculation formula in a predetermined storage region; and refer to this appropriately. In this regard, it has been explained by using the diameter as an example, but the server 10D may be configured so as to define a display size in place of the diameter.

Here, the phrase “a diameter of the boundary object becomes narrower” means that the ring-shaped object becomes smaller, and it is similar to the case where the ring-shaped object is not a perfect circular shape.

FIG. 11 is a flowchart showing an example of the display processing carried out by the system 100. Hereinafter, an operation of the server 10D side will be described as an example. In this regard, description of components or portions that have already been explained will be omitted from a point of view to avoid repeated explanation.

In the display processing, the server 10D first specifies a position of the player character (Step S101). The server 10D displays a ring-shaped, boundary object on the basis of the position of the player character so that the center of the boundary object always corresponds to the position of the player character while the boundary object is displayed, and the diameter of the boundary object narrows as the player character approaches the boundary object (Step S4-11). The server 10D then terminates the processing herein. For example, the server 10D first determines a central position of the ring-shaped object. Subsequently, the server 10D determines the diameter of the ring-shaped object by using the predetermined calculation formula defined so that the diameter of the ring-shaped object narrows as the player character approaches the ring-shaped object and the distance between the player character and the ring-shaped object. The server 10D then generates a ring-shaped object having the determined diameter at the determined central position, and displays the ring-shaped object.

As explained above, as one side of the fourth embodiment, the server 10D is configured so as to at least include the specifying section 11 and the displaying section 12D. Thus, the displaying section 12D displays the ring-shaped object as the boundary object; displays the boundary object so that the center of the boundary object always corresponds to the position of the player character while the boundary object is being displayed; and changes the state of the boundary object so that the diameter of the boundary object narrows as the player character approaches the boundary object to display the boundary object. Therefore, it is possible to cause the user to intuitively recognize the position of the boundary and the distance between the player character and the boundary without obstructing a landscape or scenery in the three-dimensional virtual space.

Namely, a position of a ring is adjusted so that the player character is always positioned at a center of the ring, and the position of the ring is always on the boundary (that is, a predetermined display portion at which the boundary object is to be displayed). In addition, a size of the ring is adjusted so as to cause the user to know whether the player character is near the boundary or not. Therefore, it becomes possible to cause the user to more intuitively recognize how much distance and what direction from the position of the player character the boundary exists.

### Fifth Embodiment

A video game that proceeds by a video game processing system according to the present embodiment is a video game in which three-dimensional movement (that is, for example, in the air or under the water, movement to a Y-Z plane in addition to conventional movement to an X-Y plane) is carried out in a three-dimensional virtual space (hereinafter, referred to also as an “area”). A boundary for moving to each of other areas is set to each area. A player character is allowed to move to any other area by coming into contact with the corresponding boundary.

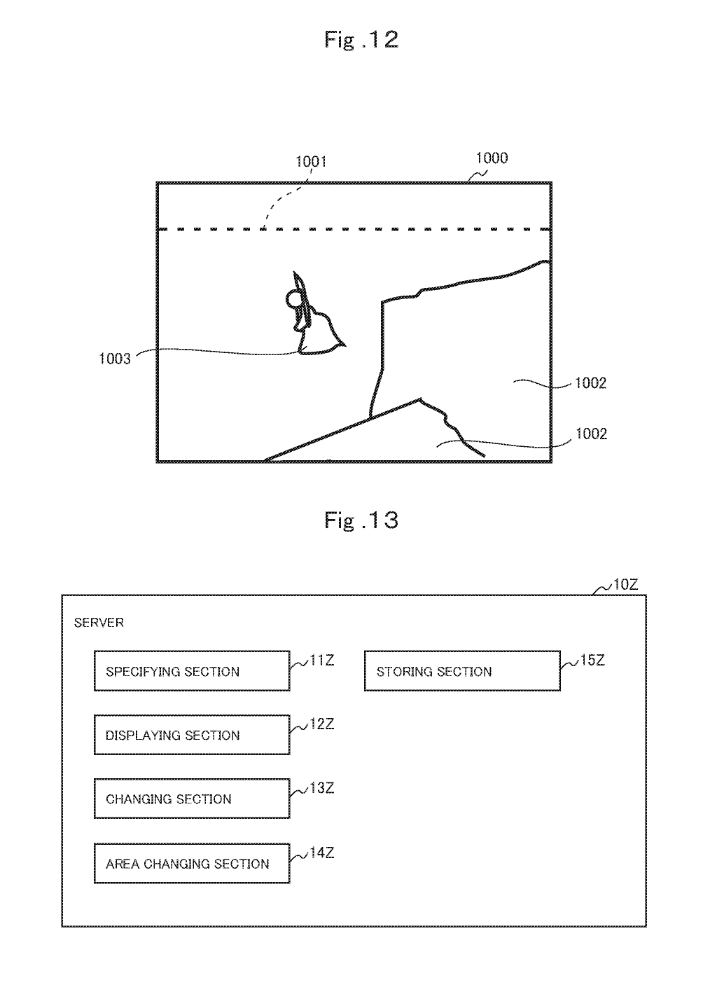

FIG. 12 is an explanatory drawing showing an example of a display screen. As shown in FIG. 12, a display screen 1000 includes a boundary 1001, an obstacle 1002, and a player character 1003. In this regard, an area displayed on the display screen 1000 is an underwater area. The boundary 1001 is formed as a line shown by a dotted line in an underwater area, and is formed in an entire area that is not delimited by a virtual obstacle 1002 that constitutes an area (for example, a geographical object, a building object, and the like). The player character 1003 is positioned at the inside of the boundary 1001. Here, the boundary 1001 is formed under the water. However, the boundary 1001 is not limited to such a configuration. For example, the boundary 1001 may be formed in the air.

FIG. 13 is a block diagram showing a configuration of a server 10Z, which is an example of the configuration of the server 10. In the present embodiment, the server 10Z at least includes a specifying section 11Z, a displaying section 12Z, a changing section 13Z, an area changing section 14Z, and a storing section 15Z.

The specifying section 11Z has a function to carry out a process to specify information regarding a position of a player character in an area and information regarding a boundary in an area in which the player character exists. The configuration of the process to specify various kinds of information is not limited particularly.

The displaying section 12Z has a function to carry out a process to change a state of a boundary object, which is an object provided on or near the boundary, on the basis of the position of the player character, and to display the boundary object. Namely, the displaying section 12Z displays the boundary object changed by the changing section 13Z (will be described later).

The changing section 13Z has a function to carry out a process to determine whether the boundary object is to be displayed or not and a process to determine in what state the boundary object is to be displayed in a case where the boundary object is to be displayed. Specifically, the changing section 13Z determines whether the boundary object is to be displayed or not on the basis of various kinds of positional information specified by the specifying section 11Z and threshold value information stored in the storing section 15Z. Further, the changing section 13Z also has a function to carry out a process to determine a size of the boundary object on the basis of the various kinds of positional information specified by the specifying section 11Z and a first calculation formula stored in the storing section 15Z. Further, the changing section 13Z also has a function to carry out a process to determine permeability of the boundary object on the basis of a distance between the player character and the boundary and a second calculation formula stored in the storing section 15Z. Further, the changing section 13Z also has a function to carry out a process to determine a position of the boundary object on the basis of the position of the player character. The changing section 13Z changes the state of the boundary object (that is, a display state thereof).

The area changing section 14Z has a function to carry out a process to determine whether the player character collides with the boundary or not and a process to change areas in a case where it is determined that the player character collides with the boundary. Further, the area changing section 14Z has a function to carry out a process to specify an area as a destination to which the player character moves as a result that an area change is carried out. Here, the configuration to determine whether the player character collides with the boundary or not is not limited particularly. As examples of the configuration to determine whether the player character collides with the boundary or not, there are a configuration to determine whether a reference position of the player character (for example, one point of a body of the player character) comes into contact with apart of the boundary or not, a configuration to determine whether the player character absolutely exceeds the boundary or not, and the like.

The storing section 15Z is a storage medium for storing various kinds of information that are used for progress of the video game. Video game proceeding information, boundary information, boundary object information, threshold value information, information regarding the first calculation formula, information regarding the second calculation formula, and the like are stored in the storing section 15Z according to the present embodiment.

Here, the video game proceeding information is information regarding progress of the video game. For example, information regarding the player character that exists in an area, information regarding an enemy character that exists in the area, and the like are contained in the video game proceeding information.

Further, the boundary information is information regarding the boundary. Information regarding the area as the destination, information regarding a position of the boundary in the area, and the like are contained in the boundary information. The boundary according to the present embodiment is defined by a predetermined surface in the area, and is defined as an entire area that is not delimited by a virtual obstacle that constitutes the area.

Further, the boundary object information is information regarding the boundary object. A standard size of the boundary object and a reference position are contained in the boundary object information. The server 10Z refers to the boundary object information to determine the size and the position of the boundary object. Further, the configuration of the standard size and the reference position is not limited particularly. The reference position according to the present embodiment is a central position of the boundary object. Namely, in a case where a display size of the boundary object is the standard size, the boundary object is displayed with the standard size by using the reference position as the center thereof.

Further, the threshold value information is information that is defined to determine whether the boundary object is to be displayed or not. Here, information regarding the distance between the player character and the boundary is defined as the threshold value information. The threshold value information is not limited particularly. For example, as an example of the configuration of the threshold value information, there is “30 m (as a distance in the area)”. In this case, when the distance between the player character and the boundary becomes “30 m (as a distance in the area)” or shorter, the boundary object is displayed.

Further, the first calculation formula is a calculation formula for determining a size of the boundary object. The first calculation formula is not limited particularly. As an example of the first calculation formula, there is a calculation formula that is configured so that the size of the boundary object becomes larger as the player character goes away from the boundary. Namely, there is a calculation formula that is configured so that the more the player character approaches the boundary, the smaller the size of the boundary object becomes. More specifically, there is a calculation formula “(display size of boundary object)=(standard size of boundary object)×(distance between player character and boundary)”. In this regard, in the present embodiment, the server 10Z is configured so as to determine a final display size on the basis of the standard size of the boundary object, which is defined in advance, in order to determine the size of the boundary object. However, the server 10Z may be configured so as to determine a final diameter on the basis of a diameter of the boundary object that is defined in advance.

Further, the second calculation formula is a calculation formula for determining permeability of the boundary object. The second calculation formula is not limited particularly. As an example of the second calculation formula, there is a calculation formula that is configured so that permeability of the boundary object becomes higher as the player character goes away from the boundary. In the present embodiment, the server 10Z is configured to display the boundary so that a rising rate of permeability is in proportion to a size of the distance until the player character approaches the boundary to a certain extent, and the permeability of the boundary is zero (that is, in a state where the boundary is completely displayed) after the player character approaches the boundary to the certain extent. More specifically, the case where the boundary object is displayed in a case where the distance between the player character and the boundary becomes “30 m (as a distance in the area)” or shorter will be described as an example. In this case, distance decay is applied until “20 m”. Namely, the rising rate of the permeability is in proportion to the size of the distance. In a case where the player character approaches the boundary by “20 m” or shorter, the boundary is clearly displayed thereafter (that is, so that the permeability thereof is set to zero). The second calculation formula according to the present embodiment is configured in this manner. In this regard, the second calculation formula is not limited to such a configuration. The server 10Z may be configured so that the rising rate of the permeability is in proportion to the size of the distance from beginning to end.

Next, an operation of the system 100 according to the present embodiment will be described.

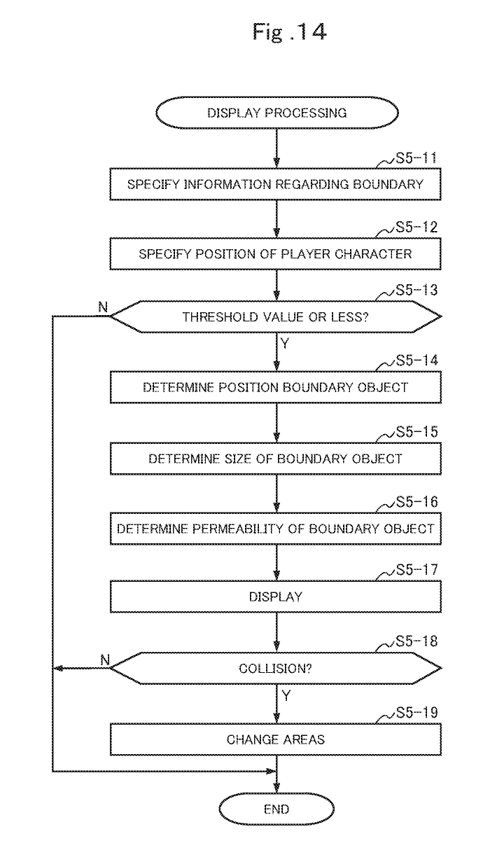

FIG. 14 is a flowchart showing an example of display processing carried out by the system 100. Hereinafter, an operation of the server 10Z side will be described as an example. In this regard, description of components or portions that have already been explained will be omitted from a point of view to avoid repeated explanation. For example, the display processing is carried out in a case where the player character operated by the user of the terminal 20 moves to an area at which the display processing is to be carried out (for example, an underwater area), or in a case where an operational input for the player character is carried out at the area at which the display processing is to be carried out.

In the display processing, the server 10Z first specifies information regarding a. boundary of an area in. which the display processing is carried out (Step S5-11). For example, the server 10Z refers to the boundary information stored in the storing section 15Z to specify information regarding the boundary in the underwater area. More specifically, the server 10Z specifies, in the underwater area, information regarding the position of the boundary and information regarding the area as the destination to which the player character moves via the boundary. In this regard, the server 10Z may be configured so that the information regarding the area as the destination to which the player character moves via the boundary is specified when to change areas. Further, the server 10Z may be configured so as to specify, in a case where a plurality of boundaries exists in the area, information for each of the boundaries. Moreover, the server 10Z may be configured so as to terminate the processing herein in a case where no boundary exists in the area.

When the boundary is specified, the server 10Z specifies a position of the player character (Step S5-12). For example, the server 10Z refers to the video game proceeding information stored in the storing section 15Z to specify the position of the player character in the area.

When the position of the player character is specified, the server 10Z determines whether a distance between the boundary and the player character becomes a threshold value or shorter or not (Step S5-13). Here, the distance between the player character and the boundary means a length of the shortest line of numerous lines each of which connects the position of the player character to the boundary. In this regard, the server 10Z may be configured so chat the distance is a distance between the player character and a portion at which the boundary object is displayed. In this case, the distance between the player character and the portion at which the boundary object is displayed may mean a length of the shortest line of numerous lines each of which connects the player character to the portion at which the boundary object is displayed.

In a case where it is determined that the distance between the boundary and the player character does not become the threshold value or shorter (“No” at Step S5-13), the server 10Z terminates the processing herein. On the other hand, in a case where it is determined that the distance between the boundary and the player character becomes the threshold value or shorter (“Yes” at Step S5-13), the server 10Z determines a display position of the boundary object on the basis of the position of the player character (Step S5-14). For example, the server 10Z determines that an intersection point between the boundary and the shortest line of numerous lines each of which connects the position of the player character to the boundary is the reference position.

When the display position of the boundary object is specified, the server 10Z determines the size of the boundary object on the basis of the distance between the boundary and the player character and the first calculation formula (Step S5-15).

When the size of the boundary object is specified, the server 10Z determines permeability of the boundary object on the basis of the distance between the player character and the boundary and the second calculation formula (Step S5-16).

When the permeability is determined, the server 10Z displays the boundary object with the position, the size, and the permeability thus determined (Step S5-17). In the present embodiment, the boundary object is not displayed on the whole boundary, but the boundary object is displayed on a part of the boundary. This makes it possible to show the boundary without hindering a landscape or scenery of an open space.

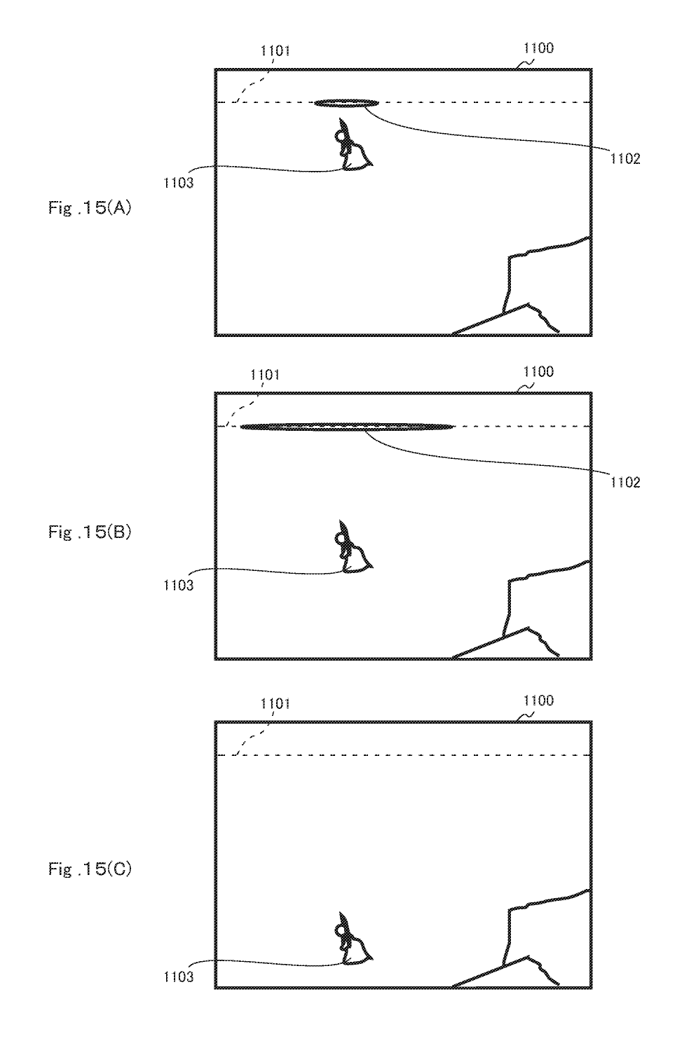

FIG. 15 is an explanatory drawing showing examples of the display screen. As shown in FIGS. 15A to 15C, a boundary 1101 displayed by a dotted line, a ring-shaped boundary object 1102, and a player character 1103 are displayed in a display screen 1100. In this regard, the boundary 1101 is not displayed on the actual display screen. As shown in FIGS. 15A and 15B, the ring-shaped boundary object 1102 is displayed so as to clearly become small as the player character 1103 approaches the boundary 1101. Further, the boundary object 1102 is displayed in a part of the boundary 1101. Further, as shown in FIG. 15C, the boundary object 1102 is not displayed when the player character 1103 goes away from the boundary 1101 to a predetermined distance. In this regard, two-dimensional display is made in FIG. 15 for convenience of explanation, but three-dimensional display is actually made.

Subsequently, the server 10Z determines whether the player character collides with the boundary or not (Step S5-18). In a case where it is determined that the player character does not collide with the boundary (“No” at Step S5-18), the server 10Z terminates the processing herein.

On the other hand, in a case where it is determined that the player character collides with the boundary (“Yes” at Step S5-18), the server 10Z refers to the information regarding the boundary, carries out changing areas (Step S5-19), and terminates the processing herein.

As explained above, as one side of the fifth embodiment, the server 10Z configured to control progress of the video game including the three-dimensional virtual space, which has the boundary through which the player character is allowed to move to another three-dimensional virtual space, is configured so as to at least include the specifying section 11Z, the displaying section 12Z, the changing section 13Z, the area changing section 14Z, and the storing section 15Z. Thus, the specifying section 11Z specifies the position of the player character in the three-dimensional virtual space; and the displaying section 12Z changes the state of the boundary object that is the object provided on or near the boundary on the basis of the position of the player character to display the boundary object. Therefore, it is possible to cause the user to recognize the boundary more intuitively, and this makes it possible to improve usability in the video game in which the player character or the like may be controlled to move toward the boundary compared with the conventional ones.

Further, as one side of the fifth embodiment, the server 10Z is configured to at least include the specifying section 11Z, the displaying section 12Z, the changing section 13Z, the area changing section 14Z, and the storing section 15Z. Thus, the displaying section 12Z changes the position of the boundary object and displays the boundary object on the basis of the change in the position of the player character. Therefore, it is possible to cause the user to recognize the boundary more intuitively, and this makes it possible to improve usability in the video game in which the player character or the like may be controlled to move toward the boundary compared with the conventional ones.

Further, as one side of the fifth embodiment, the server 10Z is configured so as to at least include the specifying section 11Z, the displaying section 12Z, the changing section 13Z, the area changing section 14Z, and the storing section 15Z. Thus, the displaying section 12Z does not display the boundary object in a case where the distance between the player character and the boundary exceeds the predetermined threshold value; and the displaying section 12Z displays the boundary object in a case where the distance between the player character and the boundary becomes the predetermined threshold value or shorter. Therefore, it is possible to cause the user to recognize the boundary more intuitively, and this makes it possible to improve usability in the video game in which the player character or the like may be controlled to move toward the boundary compared with the conventional ones.

Further, as one side of the fifth embodiment, the server 10Z is configured so as to at least include the specifying section 11Z, the displaying section 12Z, the changing section 13Z, the area changing section 14Z, and the storing section 15Z. Thus, the displaying section 12Z displays the ring-shaped object as the boundary object; displays the boundary object so that the center of the boundary object always corresponds to the position of the player character while the boundary object is displayed; and changes the state of the boundary object so that the diameter of the boundary object narrows as the player character approaches the boundary object to display the boundary object. Therefore, it is possible to cause the user to intuitively recognize the position of the boundary and the distance between the player character and the boundary without obstructing a landscape or scenery in the three-dimensional virtual space.

Further, as one side of the fifth embodiment, the server 10Z is configured so as to at least include the specifying section 11Z, the displaying section 12Z, the changing section 13Z, the area changing section 14Z, and the storing section 15Z. Thus, the displaying section 12Z sets the entire area that is not delimited by the virtual obstacle that constitutes the three-dimensional virtual space as the boundary, and displays the boundary object that is provided on or near the boundary. Therefore, it is possible to cause the user to intuitively recognize the position of the boundary and the distance between the player character and the boundary without obstructing a landscape or scenery in the three-dimensional virtual space. p Further, as one side of the fifth embodiment, the server 10Z is configured so as to at least include the specifying section 11Z, the displaying section 12Z, the changing section 13Z, the area changing section 14Z, and the storing section 15Z. Thus, the displaying section 12Z displays the boundary object that is provided on a part of the boundary. Therefore, it is possible to cause the user to intuitively recognize the position of the boundary and the distance between the player character and the boundary without obstructing a landscape or scenery in the three-dimensional virtual space.

In this regard, it has not been mentioned particularly in the fifth embodiment described above. However, the system 100 may be configured so as not to display the boundary in the three-dimensional virtual space, but to display a boundary in a plane space (that is, a two-dimensional virtual space). Namely, the present invention can also be applied to a video game that is carried out in a plane space (two-dimensional virtual space).

As explained above, one or two or more shortages can be solved by each of the embodiments according to the present application. In this regard, the effects by each of the embodiments are non-limiting effects or one example of the non-limiting effects.

In this regard, in each of the embodiments described above, each of the plurality of user terminals 20, 201 to 20N and the server 10 carries out the various kinds of processing described above in accordance with various kinds of control programs (for example, a video game processing program) stored in the storage device with which the corresponding terminal or server is provided.

Further, the case where the displaying section 12 carries out processes other than the process regarding the display (that is, the display processing), such as the process to determine, has been explained in each of the embodiments described above. However, the present invention is not limited to such a configuration, and the system 100 may be configured so as to include a determining section configured to carry out a process to determine and the like.

Further, the configuration of the system 100 is not limited to the configuration that has been explained as an example of each of the embodiments described above. For example, the system 100 may be configured so that the server 10 carries out a part or all of the processes that have been explained as the processes carried out by the user terminal. Alternatively, the system 100 may be configured so that any of the plurality of user terminals 20, 201 to 20N (for example, the user terminal 20) carries out a part or all of the processes that have been explained as the processes carried out by the server 10. Further, the system 100 may be configured so that a part or all of the storing sections included in the server 10 is included in any of the plurality of user terminals 20, 201 to 20N. Namely, the system 100 may be configured so that a part or all of the functions of any one of the user terminal 20 and the server 10 according to the system 100 is included in the other.

### Appendix

The explanation of the embodiments described above has been described so that the following inventions can be at least realized by a person having a normal skill in the art to which the present invention belongs.

(1)

A non-transitory computer-readable medium including a program for causing a server to realize functions to control progress of a video game including a three-dimensional virtual space, the three-dimensional virtual space having a boundary through which a player character is allowed to move to another three-dimensional virtual space,

wherein the functions include:

a specifying function configured to specify a position of the player character in the three-dimensional virtual space; and

a displaying function configured to change a state of a boundary object on the basis of the position of the player character to display the boundary object, the boundary object being an object that is provided on or near the boundary.

(2)

The non-transitory computer-readable medium according to (1),

wherein the displaying function includes a function configured to change a position of the boundary object on the basis of a change in the position of the player character to display the boundary object.

(3)

The non-transitory computer-readable medium according to (1) or (2),

wherein the displaying function includes a function configured not to display the boundary object in a case where a distance between the player character and the boundary exceeds a predetermined threshold value, and to display the boundary object in a case where the distance between the player character and the boundary becomes the predetermined threshold value or shorter.

(4)

The non-transitory computer-readable medium, according to any one of (1) to (3),

wherein the displaying function includes:

a function configured to display a ring-shaped object as the boundary object;

a function configured to display the boundary object so that a center of the boundary object always corresponds to the position of the player character while the boundary object is being displayed; and

a function configured to display the boundary object while changing the state of the boundary object so that a diameter of the boundary object becomes narrower as the player character approaches the boundary object.

(5)

The non-transitory computer-readable medium according to any one of (1) to (4),

wherein the displaying function includes a function configured to display the boundary object by using a position of the boundary, which is the closest to the position of the player character, as a reference position of the boundary object.

(6)

The non-transitory computer-readable medium according to any one of (1) to (5),

wherein the displaying function includes a function configured to display the boundary object so that a size of the boundary object, becomes larger and permeability of the boundary object becomes higher as the player character goes away from the boundary.

(7)

The non-transitory computer-readable medium according to any one of (1) to (6),

wherein the displaying function includes a function configured to set an entire area, which is not delimited by a virtual obstacle that constitutes the three-dimensional virtual space, as the boundary, and display the boundary object that is provided on or near the boundary.

(8)

The non-transitory computer-readable medium according to any one of (1) to (7),

wherein the displaying function includes a function configured to display the boundary object that is provided on a part of the boundary.

(9)

The non-transitory computer-readable medium according to any one of (1) to (8),

wherein the functions further include:

a moving function configured to cause the player character to move to another three-dimensional virtual space in a case where the player character comes into contact with the boundary.

(10)

A non-transitory computer-readable medium including a program product for causing a user terminal to realize at least one function of the functions that the program product described in any one of (1) to (9) causes the server to realize, the user terminal being capable of communicating with the server.

(11)

A server into which the program product contained in the non-transitory computer-readable medium according to any one of (1) to (9) is installed.

(12)

A system configured to control progress of a video game including a three-dimensional virtual space, the system comprising a communication network, a server, and a user terminal, the three-dimensional virtual space having a boundary through which a player character is allowed to move to another three-dimensional virtual space, the system comprising:

a specifying section configured to specify a position of the player character in the three-dimensional virtual space; and

a displaying section configured to change a state of a boundary object on the basis of the position of the player character to display the boundary object, the boundary object, being an object that is provided on or near the boundary.

(13)

The system according to (12),

wherein the server includes the specifying section and the displaying section, and

wherein the user terminal includes

an outputting section configured to output a game screen on a display screen of a display device on the basis of screen information for displaying a game screen indicating progress of the video game, the screen information being transmitted from the server.

(14)

A non-transitory computer-readable medium including a program product for causing a user terminal to realize functions to control progress of a video game including a three-dimensional virtual space, the three-dimensional virtual space having a boundary through which a player character is allowed to move to another three-dimensional virtual space, the user terminal being capable of communicating with a server,

wherein the server includes:

a specifying function configured to specify a position of the player character in the three-dimensional virtual space; and

a displaying function configured to change a state of a boundary object on the basis of the position of the player character to display the boundary object, the boundary object being an object that is provided on or near the boundary, and

wherein the functions include:

a receiving function configured to receive display information transmitted from the server, the display information being information for causing the user terminal to display a game screen on a display screen of the user terminal, the game screen showing progress of the video game; and

an output function configured to output the game screen to the display screen on the basis of the display information.

(15)

A non-transitory computer-readable medium including a program product for causing a user terminal to realize functions to control progress of a video game including a three-dimensional virtual space, the three-dimensional virtual space having a boundary through which a player character is allowed to move to another three-dimensional virtual space,

wherein, the functions include:

a specifying function configured to specify a position of the player character in the three-dimensional virtual space; and

a displaying function configured to change a state of a boundary object on the basis of the position of the player character to display the boundary object, the boundary object being an object that is provided on or near the boundary.

(16)

A method of controlling progress of a video game including a three-dimensional virtual space, the three-dimensional virtual space having a boundary through which a player character is allowed to move to another three-dimensional virtual space, the method comprising:

a specifying process configured to specify a position of the player character in the three-dimensional virtual space; and

a displaying process configured to change a state of a boundary object on the basis of the position of the player character to display the boundary object, the boundary object being an object that is provided on or near the boundary.

(17)

A method of controlling progress of a video game including a three-dimensional virtual space, the three-dimensional virtual space having a boundary through which a player character is allowed to move to another three-dimensional virtual space, the method being carried out by a system comprising a communication network, a server, and a user terminal, the method comprising:

a specifying process configured to specify a position of the player character in the three-dimensional virtual space; and

a displaying process configured to change a state of a boundary object on the basis of the position of the player character to display the boundary object, the boundary object being an object that is provided on or near the boundary.

According to one of the embodiments of the present invention, it is useful to control progress of a video game in which a player character or the like may be controlled to move toward a boundary.

What is claimed is:

1. A non-transitory computer-readable medium including a program for causing a server to realize functions to control progress of a video game including a three-dimensional virtual space, the three-dimensional virtual space having a boundary through which a player character is allowed to move to another three-dimensional virtual space,
wherein the functions include:
a specifying function configured to specify a position of the player character in the three-dimensional virtual space; and
a displaying function configured to change a state of a boundary object on the basis of the position of the player character to display the boundary object, the boundary object being an object that is provided on or near the boundary.

2. The non-transitory computer-readable medium according to claim 1,
wherein the displaying function includes a function configured to change a position of the boundary object on the basis of a change in the position of the player character to display the boundary object.

3. The non-transitory computer-readable medium according to claim 1,
wherein the displaying function includes a function configured not to display the boundary object in a case where a distance between the player character and the boundary exceeds a predetermined threshold value, and to display the boundary object in a case where the distance between the player character and the boundary becomes the predetermined threshold value or shorter.

4. The non-transitory computer-readable medium according to claim 1,
wherein the displaying function includes:
a function configured to display a ring-shaped object as the boundary object;
a function configured to display the boundary object so that a center of the boundary object always corresponds to the position of the player character while the boundary object is being displayed; and
a function configured to display the boundary object while changing the state of the boundary object so that a diameter of the boundary object becomes narrower as the player character approaches the boundary object.

5. The non-transitory computer-readable medium according to claim 1,
wherein the displaying function includes a function configured to display the boundary object by using a position of the boundary, which is the closest to the position of the player character, as a reference position of the boundary object.

6. The non-transitory computer-readable medium according to claim 1,
wherein the displaying function includes a function configured to display the boundary object so that a size of the boundary object becomes larger and permeability of the boundary object becomes higher as the player character goes away from the boundary.

7. The non-transitory computer-readable medium according to claim 1,
wherein the displaying function includes a function configured to set an entire area, which is not delimited by a virtual obstacle that constitutes the three-dimensional virtual space, as the boundary, and display the boundary object that is provided on or near the boundary.

8. The non-transitory computer-readable medium according to claim 1,
wherein the displaying function includes a function configured to display the boundary object that is provided on a part of the boundary.

9. The non-transitory computer-readable medium according to claim 1,
wherein the functions further include:
a moving function configured to cause the player character to move to another three-dimensional virtual space in a case where the player character comes into contact with the boundary.

10. A system configured to control progress of a video game including a three-dimensional virtual space, the system comprising a communication network, a server, and a user terminal, the three-dimensional virtual space having a boundary through which a player character is allowed to move to another three-dimensional virtual space, the system comprising:
a specifying section configured to specify a position of the player character in the three-dimensional virtual space; and
a displaying section configured to change a state of a boundary object on the basis of the position of the player character to display the boundary object, the boundary object being an object that is provided on or near the boundary.

11. A non-transitory computer-readable medium including a program product for causing a user terminal to realize functions to control progress of a video game including a three-dimensional virtual space, the three-dimensional virtual space having a boundary through which a player character is allowed to move to another three-dimensional virtual space,
wherein the functions include:
a specifying function configured to specify a position of the player character in the three-dimensional virtual space; and
a displaying function configured to change a state of a boundary object on the basis of the position of the player character to display the boundary object, the boundary object being an object that is provided on or near the boundary.
